(19) United States
(12) Patent Application Publication
(10) Pub. No.: US 2025/0162287 A1
(43) Pub. Date: May 22, 2025

(54) POLYMER INTERLAYERS WITH REDUCED SALTS

(71) Applicant: SOLUTIA INC., ST. LOUIS, MO (US)

(72) Inventor: WENJIE CHEN, AMHERST, MA (US)

(73) Assignee: SOLUTIA INC., ST. LOUIS, MO (US)

(21) Appl. No.: 18/836,168

(22) PCT Filed: Feb. 7, 2023
(86) PCT No.: PCT/US2023/062100

§ 371 Date: Aug. 6, 2024

Related U.S. Application Data
(60) Provisional application No. 63/308,136, filed on Feb. 9, 2022.

(51) Int. Cl. B32B 17/10; B32B 7/02; B32B 27/18; B32B 27/30; B32B 37/15

(52) U.S. Cl. CPC B32B 17/10036; B32B 7/02; B32B 17/10568; B32B 17/10614; B32B 17/10761; B32B 17/10807; B32B 27/18; B32B 27/30; B32B 37/153; B32B 2250/03; B32B 2307/71

(57) ABSTRACT

A polymer interlayer that resists formation of optical defects. The polymer interlayer comprises a first polymer layer (14), a second polymer layer (16), and a third polymer layer (16). The first polymer layer (14) is positioned between the second polymer layer (16) and the third polymer layer (16). The first polymer layer (14) comprises a resin including (i) less than about 10 titers of monovalent alkaline metal salt, and (ii) an organic acid scavenger in a range from 0.5 to 6 phr.

### FIELD OF THE INVENTION

The present invention is related to the field of polymer interlayers and multiple layer panels comprising polymer interlayers. More specifically, the present invention is related to the field of polymer interlayers comprising multiple polymer layers.

### DESCRIPTION OF RELATED ART

Multiple layer panels are panels comprised of two sheets of a substrate (such as, but not limited to, glass, polyester, polyacrylate, or polycarbonate) with one or more polymer interlayers sandwiched therebetween. Laminated multiple layer glass panels are commonly utilized in architectural window applications and in the windows of motor vehicles and airplanes, and in photovoltaic solar panels. The first two applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces. Additionally, the interlayer may also give the glass a preferential sound insulation rating, reduce UV and/or IR light transmission, and enhance the aesthetic appeal of the associated window. For example, laminated glass panels with desirable acoustic properties have been produced, resulting in quieter internal spaces.

Furthermore, laminated glass panels been used in vehicles equipped with heads-up display (“HUD”) systems (also referred to as head-up systems), which project an image of an instrument cluster or other important information to a location on the windshield at the eye level of the vehicle operator. Such a display allows the driver to stay focused on the upcoming path of travel while visually accessing dashboard information. Generally, the HUD system in an automobile or an aircraft uses the inner surface of the vehicle windscreen to partially reflect the projected image. However, there is a secondary reflection taking place at the outside surface of the vehicle windscreen that forms a weak secondary image or “ghost” image. Since these two reflective images are offset in position, double images are often observed, which cause an undesirable viewing experience to the driver. When the image is projected onto a windshield which has a uniform and consistent thickness, the interfering double, or reflected ghost, image is created due to the differences in the position of the projected image as it is reflected off the inside and outside surfaces of the glass.

One method of addressing these double or ghost images is to orient the inner and outer glass sheets at an angle from one another. This aligns the position of the reflected images to a single point, thereby creating a single image. Typically, this is done by displacing the outer sheet relative to the inner sheet by employing a wedge-shaped, or “tapered,” interlayer that includes at least one region of nonuniform thickness. Many conventional tapered interlayers include a constant wedge angle over the entire HUD region, although some interlayers have recently been developed that include multiple wedge angles over the HUD region.

In order to achieve the required property and performance characteristics for glass panels, it has become common practice to utilize multiple layer or multilayered interlayers. As used herein, the terms “multilayer” and “multiple layers” mean an interlayer having more than one layer, and multilayer and multiple layer may be used interchangeably. Multiple layer interlayers typically contain at least one soft layer and at least one stiff layer. As noted above, interlayers with one soft “core” layer sandwiched between two more rigid or stiff “skin” layers have been designed with sound insulation properties for the glass panel. Interlayers having the reverse configuration, that is, with one stiff layer sandwiched between two or more soft layers have been found to improve the impact performance of the glass panel and can also be designed for sound insulation. Regardless, the soft “core” layer is generally referred to as an acoustic layer (as the soft layer beneficially reduces sound transmission), while the hard “skin” layer(s) is referred to as a conventional layer, or non-acoustic layer.

The layers of the interlayer are generally produced by mixing a polymer resin such as poly(vinyl butyral) with one or more plasticizers and melt processing the mix into a sheet by any applicable process or method known to one of skill in the art, including, but not limited to, extrusion, with the layers being combined by processes such as co-extrusion and lamination. In a trilayer interlayer, the core layer may include more plasticizer than the skin layers, such that the core layer is softer than the relatively harder skin layers. Other additional ingredients, as described in more detail below, may optionally be added for various other purposes. After the interlayer sheet is formed, it is typically collected and rolled for transportation and storage and for later use in the multiple layer glass panel, as discussed below.

The following offers a simplified description of the manner in which multiple layer glass panels are generally produced in combination with the interlayers. First, a multiple layer interlayer may be co-extruded using a multiple manifold co-extrusion device. The device operates by simultaneously extruding polymer melts from each manifold toward an extrusion opening. Properties of the layers can be varied by adjusting attributes (e.g., temperature and/or opening dimensions) of the die lips at the extrusion opening. Once formed, the interlayer sheet can be placed between two glass substrates and any excess interlayer is trimmed from the edges, creating an assembly. It is not uncommon for multiple polymer interlayer sheets or a polymer interlayer sheet with multiple layers (or a combination of both) to be placed within the two glass substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high temperature and pressure lamination process, or any other method known to one of ordinary skill in the art such as, but not limited to, autoclaving.

Multilayer interlayers such as a trilayer interlayer having a soft core layer and two stiffer skin layers are known to provide beneficial acoustic damping properties. However, such interlayers, as well as glass panels containing these interlayers, can develop optical defects commonly known as “bubbles.” Specifically, during the manufacturing process of interlayers and/or laminated multiple layer glass panel constructs, bubbles commonly appear in the soft core of the interlayer. Often, such bubbles are in the form of trim or edge bubbles, which appear near the edges of the interlayers in the laminated panels. Specifically, edge bubbles are bubbles that form in the interlayer within a laminated glass panel, and particularly, within about 5 mm from the edges of the glass sheets of the glass panel. Trim bubbles are bubbles that form in excess trim portions of the interlayers that extend beyond the edges of the glass sheets of the glass panel. Most of these bubbles become visible when the autoclave pressure is released. For instance, bubble nucleation may occur inside the core layer after the pressure of the polymer drops below the solubility pressure. Other variables that are known to contribute to the bubble problem include the composition of the interlayers, the presence of environmental contaminates, and/or the rheology characteristics of the interlayers.

In addition to the above, other optical defects can often be found in polymer interlayers and/or in laminated glass panels comprising polymer interlayers. For example, conventional polymer interlayer materials can significantly discolor yellow after manufacture of the interlayer or after lamination of the interlayer as part of a glass panel.

In view of the above, there is a need in the art for the development of a multilayered interlayer that resists the formation of optical defects (i.e., yellowness discoloration or bubble formation) without a reduction in other optical, mechanical, and acoustic characteristics of a conventional multilayered interlayer. More specifically, there is a need in the art for the development of multilayered interlayers having at least one soft core layer and one stiff skin layer that resists yellowing discoloring and/or the generation of bubbles (e.g., trim or edge bubbles).

### BRIEF DESCRIPTION OF THE DRAWINGS

FIG. 1 is a schematic illustration of a laminated glass panel comprising a pair of glass plates opposing a polymer interlayer, with the polymer interlayer comprising a trilayer with a pair of skin layers opposing a core layer;

FIG. 2 is another schematic illustration of a laminated glass panel comprising a pair of glass plates opposing a polymer interlayer, with the polymer interlayer having a wedge shape;

FIG. 3 is an illustration of the structural formula of an organic acid scavenger in the form of MCS 1562; and

FIG. 4 is an illustration of the structural formula of an organic acid scavenger in the form of DER 732.

### SUMMARY

One aspect of the present invention concerns a polymer interlayer that resists formation of optical defects. The polymer interlayer comprises a first polymer layer, a second polymer layer, and a third polymer layer. The first polymer layer is positioned between the second polymer layer and the third polymer layer. The first polymer layer comprises a resin including (i) less than about 10 titers of at least one monovalent alkaline metal salt, and (ii) an organic acid scavenger in a range of 0.5 to 6 phr.

Another aspect of the present invention concerns a polymer interlayer that resists formation of optical defects. The polymer interlayer comprises a core layer, a first skin layer, and a second skin layer. The core layer is positioned between the first and second skin layers. The core layer comprises a resin including (i) less than about 10 titers of at least one monovalent alkaline metal salt, and (ii) an organic acid scavenger in a range of 0.5 to 6 phr.

Another aspect of the present invention concerns a method of forming a polymer interlayer that resists formation of optical defects. The method comprises the steps of extruding a first polymer melt to form a first polymer layer and extruding a second polymer melt to form a second polymer layer and a third polymer layer. Upon the extruding steps, the first polymer layer is positioned between the second and third polymer layers. The first polymer layer comprises a resin including (i) less than about 10 titers of at least one monovalent alkaline metal salt, and (ii) an organic acid scavenger in a range of 0.5 to 6 phr.

An additional aspect of the present invention concerns a laminated glass panel that resists formation of optical defects. The laminated glass panel comprises a first glass sheet, a second glass sheet, and a polymer interlayer laminated between the first glass sheet and the second glass sheet. The polymer interlayer comprises a first polymer layer, a second polymer layer, and a third polymer layer, with the first polymer layer being positioned between the second polymer layer and the third polymer layer. The first polymer layer comprises a resin including no more than about 35 titers of alkaline metal salts, wherein at least 5 titers of the alkaline metal salt is potassium acetate.

A further aspect of the present invention concerns another laminated glass panel that resists formation of optical defects. The laminated glass panel comprises a first glass sheet, a second glass sheet, and a polymer interlayer positioned between the first glass sheet and the second glass sheet. The polymer interlayer comprises a first polymer layer, a second polymer layer, and a third polymer layer, with the first polymer layer being positioned between the second polymer layer and the third polymer layer. The first polymer layer comprises a resin including no more than about 35 titers of alkaline metal salts, wherein at least 5 titers of the alkaline metal salt is potassium acetate.

### DETAILED DESCRIPTION

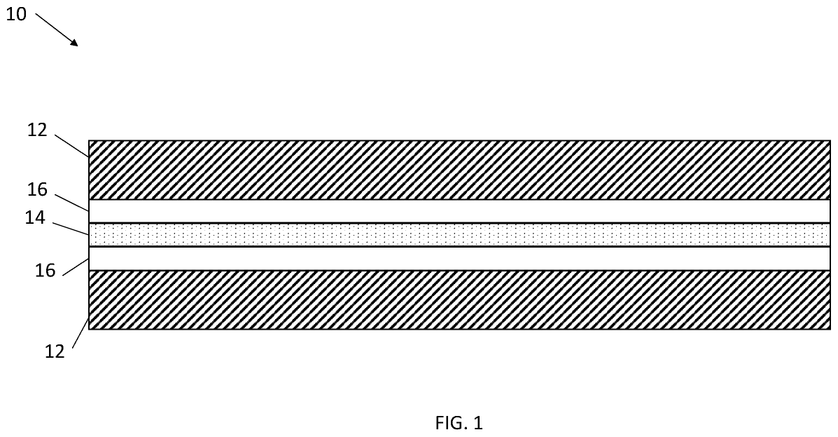

Embodiments of the present invention are directed to multiple layer panels and methods of making multiple layer panels. Generally, multiple layer panels are comprised of two sheets of glass, or other applicable substrates, with a polymer interlayer sheet or sheets sandwiched there-between. Multiple layer panels are generally produced by placing at least one polymer interlayer sheet between two substrates to create an assembly. FIG. 1 illustrates a multiple layer panel 10 comprising a pair of glass sheets 12 with a multilayered interlayer sandwiched therebetween. The multilayered interlayer is configured as a trilayer interlayer having three individual polymer interlayer sheets, including a soft core layer 14 and two relatively stiffer skin layers 16 positioned on either side of the core layer 14.

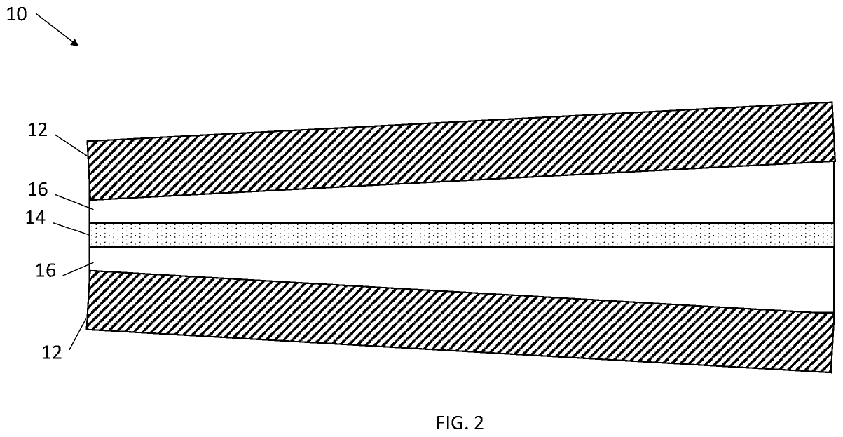

In some embodiments, the interlayer (e.g., the core layer 14 and the skin layers 16) will have a generally constant or uniform thickness about the length of the interlayer. However, in alternative embodiments, as shown in FIG. 2, the interlayer may have at least one region of non-uniform thickness. For example, the interlayer, comprised of the core layer 14 and skin layers 16, may be wedge-shaped, such that the thickness of the interlayer changes (e.g., linearly or non-linearly) about the length of the interlayer. In some such embodiments, the thickness of the interlayer may change due to a thickness change in the core layer 14 (i.e., with the skin layers 16 having a generally constant thickness). Alternatively, the thickness of the interlayer may change due to a thickness change in the skin layers 16 (i.e., with the core layer 14 having a generally constant thickness). In further alternatives, the thickness of the interlayer may change due to a thickness change in both the core layer 14 and the skin layers 16.

In order to facilitate a more comprehensive understanding of the interlayers and multiple layer panels disclosed herein, the meaning of certain terms, as used in this application, will be defined. These definitions should not be taken to limit these terms as they are understood by one of ordinary skill, but simply to provide for improved understanding of how certain terms are used herein.

The terms “polymer interlayer sheet,” “interlayer,” “polymer layer”, and “polymer melt sheet” as used herein, may designate a single-layer sheet or a multilayered interlayer. A “single-layer sheet,” as the names implies, is a single polymer layer extruded as one layer. A multilayered interlayer, on the other hand, may comprise multiple layers, including separately extruded layers, co-extruded layers, or any combination of separately and co-extruded layers. Thus, the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. In various embodiments of the present invention, a multilayered interlayer comprises at least two polymer layers (e.g., a single layer or multiple layers co-extruded) disposed in direct contact with each other, wherein each layer comprises at least one polymer resin. The term “resin,” as utilized herein refers to the polymeric component (e.g., PVB) removed from the processes, such as those discussed more fully below. Generally, plasticizer, such as those discussed more fully below, is added to the resins to result in a plasticized polymer. Additionally, resins may have other components in addition to the polymer and plasticizer including; e.g., acetates, salts and alcohols, as further discussed herein. However, as will be discussed in more detail below, polymer interlayers formed according to embodiments of the present invention may have one or more layers formed with resins that have reduced amounts of alkaline salt, and more specifically in some embodiments, reduced amounts of monovalent alkaline metal salt (compared to typical interlayers).

It should also be noted that while poly(vinyl butyral) (“PVB”) interlayers are often specifically discussed as the polymer resin of the polymer interlayers in this application, it should be understood that other thermoplastic interlayers besides PVB interlayers may be used. Contemplated polymers include, but are not limited to, polyurethane, polyvinyl chloride, poly(ethylene vinyl acetate) and combinations thereof. These polymers can be utilized alone, or in combination with other polymers. Accordingly, it should be understood that when ranges, values and/or methods are given for a PVB interlayer in this application (e.g., plasticizer component percentages, thickness and characteristic-enhancing additives), those ranges, values and/or methods also apply, where applicable, to the other polymers and polymer blends disclosed herein or could be modified, as would be known to one of ordinary skill, to be applied to different materials.

As used herein, the term “molecular weight” refers to weight average molecular weight (Mw). The molecular weight of the PVB resin can be in the range of from about 50,000 to about 600,000, about 70,000 to about 450,000, or about 100,000 to about 425,000 Daltons.

The PVB resin may be produced by known aqueous or solvent acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Wade, B. (2016), “Vinyl Acetal Polymers”, Encyclopedia of Polymer Science and Technology, pp. 1-22 (John Wiley & Sons, Inc.), the entire disclosures of which are incorporated herein by reference.

While generally referred herein as “poly(vinyl acetal)” or “poly(vinyl butyral)”, the resins described herein may include residues of any suitable aldehyde, including, but not limited to, isobutyraldehyde. In some embodiments, one or more poly(vinyl acetal) resin can include residues of at least one C₁ to C₁₀ aldehyde, or at least one C₄ to C₈ aldehyde. Examples of suitable C₄ to C₈ aldehydes can include, but are not limited to, n-butyraldehyde, isobutyraldehyde, 2-methylvaleraldehyde, n-hexyl aldehyde, 2-ethylhexyl aldehyde, n-octyl aldehyde, and combinations thereof.

In many embodiments, plasticizers are added to the polymer resin to form polymer layers or interlayers. Plasticizers are generally added to the polymer resin to increase the flexibility and durability of the resultant polymer interlayer. Plasticizers function by embedding themselves between chains of polymers, spacing them apart (increasing the “free volume”) and thus significantly lowering the glass transition temperature (T_{g}) of the polymer resin, making the material softer. In this regard, the amount of plasticizer in the interlayer can be adjusted to affect the glass transition temperature (T_{g}). The glass transition temperature (T_{g}) is the temperature that marks the transition from the glassy state of the interlayer to the rubbery state. In general, higher amounts of plasticizer loading can result in lower (T_{g}). In some embodiments, such as when the interlayer is an acoustic trilayer, the inner core layer (i.e., the soft layer) will have a glass transition temperature less than about 20° C., while the outer skin layers (e.g., the stiff layer) will have a glass transition temperature greater than about 25° C.

Contemplated plasticizers include, but are not limited to, esters of a polybasic acid, a polyhydric alcohol, triethylene glycol di-(2-ethylbutyrate), triethylene glycol di-(2-ethylhexonate) (known as “3-GEH”), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, and polymeric plasticizers such as oil-modified sebacic alkyds and mixtures of phosphates and adipates, and mixtures and combinations thereof. 3-GEH is particularly preferred. Other examples of suitable plasticizers can include, but are not limited to, tetraethylene glycol di-(2-ethylhexanoate) (“4-GEH”), di(butoxyethyl) adipate, and bis(2-(2-butoxyethoxy)ethyl) adipate, dioctyl sebacate, nonylphenyl tetraethylene glycol, and mixtures thereof.

Other suitable plasticizers may include blends of two or more distinct plasticizers, including but not limited to those plasticizers described above. Still other suitable plasticizers, or blends of plasticizers, may be formed from aromatic groups, such polyadipates, epoxides, phthalates, terephthalates, benzoates, toluates, mellitates and other specialty plasticizers. Further examples include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), ethoxylated nonylphenol, and mixtures thereof. In some embodiments, the plasticizer can be selected from the group consisting of dipropylene glycol dibenzoates, tripropylene glycol dibenzoates, and combinations thereof.

Generally, the plasticizer content of the polymer interlayers of this application are measured in parts per hundred resin parts (“phr”), on a weight per weight basis. For example, if 30 grams of plasticizer is added to 100 grams of polymer resin, the plasticizer content of the resulting plasticized polymer would be 30 phr. When the plasticizer content of a polymer layer is given in this application, the plasticizer content of the particular layer is determined in reference to the phr of the plasticizer in the melt that was used to produce that particular layer.

According to some embodiments of the present invention, one or more polymer layers described herein can have a total plasticizer content of at least about 20 phr, at least about 25 phr, at least about 30 phr, at least about 35 phr, at least about 38 phr, at least about 40 phr, at least about 45 phr, at least about 50 phr, at least about 55 phr, at least about 60 phr, at least about 65 phr, at least about 67 phr, at least about 70 phr, at least about 75 phr of one or more plasticizers. In some embodiments, the polymer layer may also include not more than about 100 phr, not more than about 85 phr, not more than 80 phr, not more than about 75 phr, not more than about 70 phr, not more than about 65 phr, not more than about 60 phr, not more than about 55 phr, not more than about 50 phr, not more than about 45 phr, not more than about 40 phr, not more than about 38 phr, not more than about 35 phr, or not more than about 30 phr of one or more plasticizers. In some embodiments, the total plasticizer content of at least one polymer layer can be in the range of from about 20 to about 40 phr, about 20 to about 38 phr, or about 25 to about 35 phr. In other embodiments, the total plasticizer content of at least one polymer layer can be in the range of from about 38 to about 90 phr, about 40 to about 85 phr, or about 50 to 70 phr.

When the interlayer includes a multiple layer interlayer, two or more polymer layers within the interlayer may have substantially the same plasticizer content and/or at least one of the polymer layers may have a plasticizer content different from one or more of the other polymer layers. When the interlayer includes two or more polymer layers having different plasticizer contents, the two layers may be adjacent to one another. In some embodiments, the difference in plasticizer content between adjacent polymer layers can be at least about 1, at least about 2, at least about 5, at least about 7, at least about 10, at least about 20, at least about 30, at least about 35 phr and/or not more than about 80, not more than about 55, not more than about 50, or not more than about 45 phr, or in the range of from about 1 to about 60 phr, about 10 to about 50 phr, or about 30 to 45 phr. When three or more layers are present in the interlayer, at least two of the polymer layers of the interlayer may have similar plasticizer contents falling for example, within 10, within 5, within 2, or within 1 phr of each other, while at least two of the polymer layers may have plasticizer contents differing from one another according to the above ranges.

In some embodiments, one or more polymer layers or interlayers described herein may include a blend of two or more plasticizers including, for example, two or more of the plasticizers listed above. When the polymer layer includes two or more plasticizers, the total plasticizer content of the polymer layer and the difference in total plasticizer content between adjacent polymer layers may fall within one or more of the ranges above. When the interlayer is a multiple layer interlayer, one or more than one of the polymer layers may include two or more plasticizers. In some embodiments when the interlayer is a multiple layer interlayer, at least one of the polymer layers including a blend of plasticizers may have a glass transition temperature higher than that of conventional plasticized polymer layer. This may provide, in some cases, additional stiffness to layer which can be used, for example, as an outer “skin” layer in a multiple layer interlayer.

In addition to plasticizers, it is also contemplated that adhesion control agents (“ACAs”) may be added to the polymer resins to form polymer interlayers. When used in a monolithic interlayer or in the outer layers of a multilayer interlayer, ACAs generally function to alter and/or improve the adhesion of the interlayer to the glass panels when forming a laminated panel. Such ACAs may also be used to improve the overall stability of the resin, particularly when used in an inner or core layer. It is believed that the metal salts, when used in an inner or core layer, function as acid scavengers. Contemplated ACAs or metal salts include, but are not limited to, salts such as monovalent and multivalent metal salts. Contemplated salts include, for example, magnesium carboxylates/salts, such as magnesium di-2-ethylhexanoate, magnesium bis 2-ethylbutyrate, or other organic magnesium salts. Contemplated ACAs may also include salts in the form of magnesium acetate (i.e., Mg(OAc)₂). Still other contemplated ACAs include monovalent alkaline metal salts in the form of potassium acetate (i.e., potassium salt of acetic acetate or “KOAc”). The following is an exemplary list of monovalent metal salts that may be used as ACAs according to embodiments of the present invention: potassium formate, potassium 2-ethylbutyrate, potassium 2-ethylhexanoate, sodium formate, sodium acetate, sodium 2-ethylbutyrate, sodium 2-ethylhexanoate, and the like. The following is an exemplary list of multivalent metal salts that may be used as ACAs according to embodiments of the present invention: magnesium formate, magnesium di-2-ethylhexanoate, magnesium salicylate, calcium formate, calcium acetate, calcium 2-ethylbutyrate, calcium 2-ethylhexonate, and the like. In addition, contemplated ACAs may further include those ACAs disclosed in U.S. Pat. No. 5,728,472, incorporated by reference herein in its entirety. It is understood that the ACAs included in the polymer resins and/or the polymer interlayers discussed herein may comprise various combinations of the exemplary ACAs listed above.

In addition to plasticizers and metal salts, it is further contemplated that organic acid scavengers may be added to the polymer resins that are used to form polymer interlayers. Organic acid scavengers generally function to neutralize acids without forming salts. However, use of organic acid scavengers within polymer resins has also been found to stabilize the resins and the resulting polymer layers. In more detail, it is understood that the presence of salts within a resin can, in some situations, lead to the formation of optical defects, such as yellow discoloration and/or bubble formation. Such optical defects are believed to be due to the formation of nucleation sites within the resin where the salt is located. The presence of salt within a resin can be the result of ACA (generally comprised of salts), decomposition of plasticizers, decomposition of the resin, and/or oxidation of organic volatiles. However, simply removing ACA or metal salts from a polymer resin can be problematic. As will be described in more detail below, reducing the amount of ACA or metal salts used in a polymer resin can destabilize the resin, leading to optical defects such as an increased yellow discoloration in the resulting polymer layer, polymer interlayer, and/or laminated glass panel. To address such optical defects, embodiments of the present invention incorporate the use of organic acid scavengers within the polymer resin, in place of or in addition to the metal salts. As described in more detail below, use of such organic acid scavengers has been found to stabilize the polymer resin (and resulting polymer layer and/or interlayer).

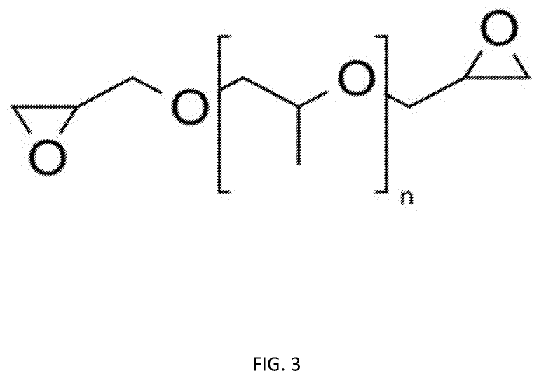

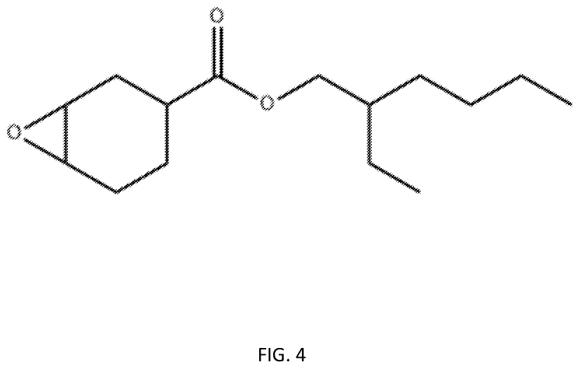

In general, organic acid scavengers may comprise epoxide derivatives, such as mono-epoxides, di-epoxides, and/or epoxidized vegetable oils. An example of a suitable mono-epoxide is 2-ethylhexyl epoxy cyclohexyl carboxylate, which is commercialized as MCS 1562. FIG. 3 illustrates the structural formula of MCS 1562. An example of a suitable di-epoxide is a liquid epoxy resin produced from a reaction of epichlorohydrin and polypropylene glycol, which is commercialized as DER 732 by Dow Chemical Company. FIG. 4 illustrates the structural formula of DER 732. Suitable epoxidized vegetable oils include soybean oil, linseed oil, and the like. Furthermore, contemplated organic acid scavengers may also include epoxidized octyl stearate or epoxidized polybutadiene.

Other additives may be incorporated into the polymer resins that form polymer interlayers, so as to enhance the performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, UV stabilizers, dispersants, surfactants, chelating agents, coupling agents, adhesives, primers, reinforcement additives, and fillers, among other additives known to those of ordinary skill in the art.

One parameter used to describe the polymer resin components of the polymer interlayers of this application is residual hydroxyl content (as vinyl hydroxyl content or poly(vinyl alcohol) (“PVOH”) content). Residual hydroxyl content refers to the amount of hydroxyl groups remaining as side groups on the chains of the polymer after processing is complete. For example, PVB can be manufactured by hydrolyzing poly(vinyl acetate) to poly(vinyl alcohol), and then reacting the poly(vinyl alcohol) with butyraldehyde to form PVB. In the process of hydrolyzing the poly(vinyl acetate), typically not all the acetate side groups are converted to hydroxyl groups. Further, the reaction with butyraldehyde typically will not result in all the hydroxyl groups being converted into acetal groups. Consequently, in any finished PVB, there will typically be residual acetate groups (such as vinyl acetate groups) and residual hydroxyl groups (such as vinyl hydroxyl groups) as side groups on the polymer chain. Generally, the residual hydroxyl content of a polymer can be regulated by controlling the reaction times and reactant concentrations, among other variables in the polymer manufacturing process. When utilized as a parameter herein, the residual hydroxyl content is measured on a weight percent (wt. %) basis per ASTM D-1396.

In various embodiments, the poly(vinyl butyral) resin comprises about 8 to about 35 wt. % residual hydroxyl groups calculated as PVOH, about 13 to about 30 wt. % residual hydroxyl groups calculated as PVOH, about 8 to about 22 wt. % residual hydroxyl groups calculated as PVOH, or about 15 to about 22 wt. % residual hydroxyl groups calculated as PVOH; and for some of the high rigidity interlayers disclosed herein, for one or more of the layers, the poly(vinyl butyral) resin comprises greater than about 19 wt. % residual hydroxyl groups calculated as PVOH, greater than about 20 wt. % residual hydroxyl groups calculated as PVOH, greater than about 20.4 wt. % residual hydroxyl groups calculated as PVOH, and greater than about 21 wt. % residual hydroxyl groups calculated as PVOH.

In some embodiments, the poly(vinyl butyral) resin used in at least one polymer layer of an interlayer may include a poly(vinyl butyral) resin that has a residual hydroxyl content of at least about 18, at least about 18.5, at least about 18.7, at least about 19, at least about 19.5, at least about 20, at least about 20.5, at least about 21, at least about 21.5, at least about 22, at least about 22.5 wt. % and/or not more than about 30, not more than about 29, not more than about 28, not more than about 27, not more than about 26, not more than about 25, not more than about 24, not more than about 23, or not more than about 22 wt. %, measured as described above.

Additionally, one or more other polymer layers in the interlayers described herein may include another poly(vinyl butyral) resin that has a lower residual hydroxyl content. For example, in some embodiments, at least one polymer layer of the interlayer can include a poly(vinyl butyral) resin having a residual hydroxyl content of at least about 8, at least about 8.5, at least about 9, at least about 9.5, at least about 10, at least about 10.5, at least about 11, at least about 11.5, at least about 12, at least about 13 wt. % and/or not more than about 16, not more than about 15, not more than about 14, not more than about 13.5, not more than about 13, not more than about 12, or not more than about 11.5 wt. %, measured as described above.

When the interlayer includes two or more polymer layers, the layers may include poly(vinyl butyral) resins that have substantially the same residual hydroxyl content, or the residual hydroxyl contents of the poly(vinyl butyral) resins in each layer may differ from each other. When two or more layers include poly(vinyl butyral) resins having substantially the same residual hydroxyl content, the difference between the residual hydroxyl contents of the poly(vinyl butyral) resins in each layer may be less than about 2, less than about 1, or less than about 0.5 wt. %. As used herein, the terms “weight percent different” and “the difference between . . . is at least . . . weight percent” refer to a difference between two given weight percentages, calculated by subtracting one number from the other. For example, a poly(vinyl acetal) resin having a residual hydroxyl content of 12 wt. % has a residual hydroxyl content that is 2 wt. % different than a poly(vinyl acetal) resin having a residual hydroxyl content of 14 wt. % (14 wt. %−12 wt. %=2 wt. %). As used herein, the term “different” can refer to a value that is higher than or lower than another value. Unless otherwise specified, all “differences” herein refer to the numerical value of the difference and not to the specific sign of the value due to the order in which the numbers were subtracted. Accordingly, unless noted otherwise, all “differences” herein refer to the absolute value of the difference between two numbers.

When two or more layers include poly(vinyl butyral) resins having different residual hydroxyl contents, the difference between the residual hydroxyl contents of the poly(vinyl butyral) resins can be at least about 2, at least about 3, at least about 4, at least about 5, at least about 6, at least about 7, at least about 8, at least about 9, at least about 10, at least about 12, at least about 15 wt. %, measured as described above.

The resin can also comprise less than 35 wt. % residual ester groups, less than 30 wt. %, less than 25 wt. %, less than 15 wt. %, less than 13 wt. %, less than 11 wt. %, less than 9 wt. %, less than 7 wt. %, less than 5 wt. %, less than 3 wt. %, or less than 1 wt. % residual ester groups calculated as polyvinyl ester, e.g., acetate, with the balance being an acetal, preferably butyraldehyde acetal, but optionally including other acetal groups in a minor amount, for example, a 2-ethyl hexanal group (see, for example, U.S. Pat. No. 5,137,954, the entire disclosure of which is incorporated herein by reference). The residual acetate content of a resin may also be determined according to ASTM D-1396.

In some embodiments, as described above, one or more of the polymer layers of the interlayer may be formed from poly(vinyl acetal) resin. Such poly(vinyl acetal) resin may have a residual acetate content of at least about 1, at least about 3, at least about 5, at least about 7 wt. % and/or not more than about 15, not more than about 12, not more than about 10, not more than about 8 wt. %, measured as described above. When the interlayer comprises a multiple layer interlayer, two or more polymer layers can include resins having substantially the same residual acetate content, or one or more resins in various layers can have substantially different acetate contents. When the residual acetate contents of two or more resins are substantially the same, the difference in the residual acetate contents may be, for example, less than about 3, less than about 2, less than about 1, or less than about 0.5 wt. %. In some embodiments, the difference in residual acetate content between two or more poly(vinyl butyral) resins in a multiple layer interlayer can be at least about 3, at least about 5, at least about 8, at least about 15, at least about 20, or at least about 30 wt. %. When such resins are utilized in a multiple layer interlayer, the resins having different residual acetate contents may be located in adjacent polymer layers. When the multiple layer interlayer is a three-layer interlayer including a pair of outer “skin” layers surrounding, or sandwiching, an inner “core” layer, for example, the core layer may include a resin having higher or lower residual acetate content. At the same time, the resin in the inner core layer can have a residual hydroxyl content that is higher or lower than the residual hydroxyl content of the outer skin layer and fall within one or more of the ranges provided previously.

Poly(vinyl acetal) resins having higher or lower residual hydroxyl contents and/or residual acetate contents may also, when combined with at least one plasticizer, ultimately include different amounts of plasticizer. As a result, layers or domains formed of first and second poly(vinyl acetal) resins having different compositions may also have different properties within a single polymer layer or interlayer. Notably, for a given type of plasticizer, the compatibility of the plasticizer in the polymer is largely determined by the hydroxyl content of the polymer. Polymers with a greater residual hydroxyl content are typically correlated with reduced plasticizer compatibility or capacity. Conversely, polymers with a lower residual hydroxyl content typically will result in increased plasticizer compatibility or capacity. As a result, poly(vinyl acetal) resins with higher residual hydroxyl contents tend to be less plasticized and exhibit higher stiffness than similar resins having lower residual hydroxyl contents. Conversely, poly(vinyl acetal) resins having lower residual hydroxyl contents may tend to, when plasticized with a given plasticizer, incorporate higher amounts of plasticizer, which may result in a softer polymer layer that exhibits a lower glass transition temperature than a similar resin having a higher residual hydroxyl content. Depending on the specific resin and plasticizer, these trends could be reversed.

When two poly(vinyl acetal) resins having different levels of residual hydroxyl content are blended with a plasticizer, the plasticizer may partition between the polymer layers or domains, such that more plasticizer can be present in the layer or domain having the lower residual hydroxyl content and less plasticizer may be present in the layer or domain having the higher residual hydroxyl content. Ultimately, a state of equilibrium is achieved between the two resins. Generally, this correlation between the residual hydroxyl content of a polymer and plasticizer compatibility/capacity can be manipulated and exploited to allow for addition of the proper amount of plasticizer to the polymer resin and to stably maintain differences in plasticizer content within multilayered interlayers. Such a correlation also helps to stably maintain the difference in plasticizer content between two or more resins when the plasticizer would otherwise migrate between the resins.

As a result of the migration of plasticizer within an interlayer, the glass transition temperatures of one or more polymer layers may be different when measured alone or as part of a multiple layer interlayer. In some embodiments, the interlayer can include at least one polymer layer having a glass transition temperature, outside of an interlayer, of at least about 33, at least about 34, at least about 35, at least about 36, at least about 37, at least about 38, at least about 39, at least about 40, at least about 41, at least about 42, at least about 43, at least about 44, at least about 45, or at least about 46° C. In some embodiments, the same layer may have a glass transition temperature within the polymer layer of at least about 34, at least about 35, at least about 36, at least about 37, at least about 38, at least about 39, at least about 40, at least about 41, at least about 42, at least about 43, at least about 44, at least about 45, at least about 46, at least about 47° C.

In the same or other embodiments, at least one other polymer layer of the multiple layer interlayer can have a glass transition temperature less than 30° C. and may, for example, have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, not more than about 0, not more than about −1, not more than about −2° C., or not more than about −5° C., measured when the interlayer is not part of an interlayer. The same polymer layer may have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, or not more than about 0° C., when measured outside of the interlayer.

According to some embodiments, the difference between the glass transition temperatures of two polymer layers, typically adjacent polymer layers within an interlayer, can be at least about 5, at least about 10, at least about 15, at least about 20, at least about 25, at least about 30, at least about 35, at least about 40, or at least about 45° C., while in other embodiments, two or more polymer layers can have a glass transition temperature within about 5, about 3, about 2, or about 1° C. of each other. Generally, the lower glass transition temperature layer has a lower stiffness than the higher glass transition temperature layer or layers in an interlayer and may be located between higher glass transition temperature polymer layers in the final interlayer construction.

For example, in some embodiments of this application, the increased acoustic attenuation properties of soft layers are combined with the mechanical strength of stiff/rigid layers to create a multilayered interlayer. In these embodiments, a central soft layer is sandwiched between two stiff/rigid outer layers. This configuration of (stiff)//(soft)//(stiff) creates a multilayered interlayer that is easily handled, can be used in conventional lamination methods and that can be constructed with layers that are relatively thin and light. The soft layer is generally characterized by a lower residual hydroxyl content (e.g., less than or equal to 16 wt. %, less than or equal to 15 wt. %, or less than or equal to 12 wt. % or any of the ranges disclosed above), a higher plasticizer content (e.g., greater than or equal to about 48 phr or greater than or equal to about 70 phr, or any of the ranges disclosed above) and/or a lower glass transition temperature (e.g., less than 30° C. or less than 10° C., or any of the ranges disclosed above).

It is contemplated that polymer interlayer sheets as described herein may be produced by any suitable process known to one of ordinary skill in the art of producing polymer interlayer sheets that are capable of being used in a multiple layer panel (such as a glass laminate). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through extrusion and/or co-extrusion processes. The final multiple layer glass panel laminate of the present disclosure are formed using processes known in the art.

In the extrusion process, thermoplastic resin and plasticizers, ACAs and/or metal salts, and/or organic acid scavengers, including any of those resins and plasticizers, ACAs, metal salts, and/or organic acid scavengers described above, are generally pre-mixed and fed into an extruder device. Other additives such as colorants and UV inhibitors (in liquid, powder, or pellet form) may be used and can be mixed into the resin prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the particles of the thermoplastic raw material and plasticizers, including any of those resins, plasticizers, and other additives described above, are further mixed and melted, resulting in a melt that is generally uniform in temperature and composition. Embodiments of the present invention may provide for the melt temperature to be approximately 200° C. Once the melt reaches the end of the extruder device, the melt is propelled into the extruder die. The extruder die is the component of the extruder device which gives the final polymer interlayer sheet product its profile. The die will generally have an opening, defined by a lip, that is substantially greater in one dimension than in a perpendicular dimension. Generally, the die is designed such that the melt evenly flows from a cylindrical profile coming out of the die and into the product's end profile shape. A plurality of shapes can be imparted to the end polymer interlayer sheet by the die so long as a continuous profile is present. Generally, in its most basic sense, extrusion is a process used to create objects of a fixed cross-sectional profile. This is accomplished by pushing or drawing a material through a die of the desired cross-section for the end product.

In some embodiments, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. For example, the multiple layer interlayers of the present invention (e.g., in the form of a trilayer interlayer) may be preferably co-extruded using a multiple manifold co-extrusion device which includes a first die manifold, a second die manifold, and a third die manifold. The co-extrusion device may operate by simultaneously extruding polymer melts from each manifold through a die and out of an opening, where the multiple layer interlayer is extruded as a composite of three individual polymer layers. The polymer melts may flow through the die such that the core layer is positioned between the skin layers, to result in the manufacture of a trilayer interlayer with the core layer sandwiched between the skin layers. The die opening may include a pair of lips positioned on either side of the opening. Given the positional orientation of the polymer melts, the skin layers may come into contact with the lips. Regardless, the interlayer thickness can be varied by adjusting the distance between die lips located at the die opening.

The thickness of the multiple polymer layers leaving the extrusion die in the co-extrusion process can generally be controlled by adjustment of the relative speeds of the melt through the extrusion die and by the sizes of the individual die lips. According to some embodiments, the total thickness of the multiple layer interlayer can be at least about 13 mils, at least about 20, at least about 25, at least about 27, at least about 30, at least about 31 mils and/or not more than about 75, not more than about 70, not more than about 65, not more than about 60 mils, or it can be in the range of from about 13 to about 75 mils, about 25 to about 70 mils, or about 30 to 60 mils. When the interlayer comprises two or more polymer layers, each of the layers can have a thickness of at least about 2, at least about 3, at least about 4, at least about 5, at least about 6, at least about 7, at least about 8, at least about 9, at least about 10 mils and/or not more than about 50, not more than about 40, not more than about 30, not more than about 20, not more than about 17, not more than about 15, not more than about 13, not more than about 12, not more than about 10, not more than about 9 mils. In some embodiments, each of the layers may have approximately the same thickness, while in other embodiments, one or more layers may have a different thickness than one or more other layers within the interlayer. Other thicknesses may be selected depending on the desired application and properties.

In some embodiments wherein the interlayer comprises at least three polymer layers, one or more of the inner layers can be relatively thin, as compared to the other outer layers. For example, in some embodiments wherein the multiple layer interlayer is a three-layer interlayer, the innermost layer can have a thickness of not more than about 12, not more than about 10, not more than about 9, not more than about 8, not more than about 7, not more than about 6, not more than about 5 mils, or it may have a thickness in the range of from about 2 to about 12 mils, about 3 to about 10 mils, or about 4 to about 9 mils. In the same or other embodiments, the thickness of each of the outer layers can be at least about 4, at least about 5, at least about 6, at least about 7 mils and/or not more than about 15, not more than about 13, not more than about 12, not more than about 10, not more than about 9, not more than about 8 mils, or can be in the range of from about 2 to about 15, about 3 to about 13, or about 4 to about 10 mils. When the interlayer includes two outer layers, these layers can have a combined thickness of at least about 9, at least about 13, at least about 15, at least about 16, at least about 18, at least about 20, at least about 23, at least about 25, at least about 26, at least about 28, or at least about 30 mils, and/or not more than about 73, not more than about 60, not more than about 50, not more than about 45, not more than about 40, not more than about 35 mils, or in the range of from about 9 to about 70 mils, about 13 to about 40 mils, or about 25 to about 35 mils.

According to some embodiments, the ratio of the thickness of one of the outer layers to one of the inner layers in a multiple layer interlayer can be at least about 1.4:1, at least about 1.5:1, at least about 1.8:1, at least about 2:1, at least about 2.5:1, at least about 2.75:1, at least about 3:1, at least about 3.25:1, at least about 3.5:1, at least about 3.75:1, or at least about 4:1. When the interlayer is a three-layer interlayer having an inner core layer disposed between a pair of outer skin layers, the ratio of the thickness of one of the skin layers to the thickness of the core layer may fall within one or more of the ranges above. In some embodiments, the ratio of the combined thickness of the outer layers to the inner layer can be at least about 2.25:1, at least about 2.4:1, at least about 2.5:1, at least about 2.8:1, at least about 3:1, at least about 3.5:1, at least about 4:1, at least about 4.5:1, at least about 5:1, at least about 5.5:1, at least about 6:1, at least about 6.5:1, or at least about 7:1 and/or not more than about 30:1, not more than about 20:1, not more than about 15:1, not more than about 10:1, not more than about 9:1, not more than about 8:1.

Multiple layer interlayers as described herein can comprise generally flat interlayers having substantially the same thickness along the length, or longest dimension, and/or width, or second longest dimension, of the sheet. In some embodiments, however, the multiple layer interlayers of the present invention can be tapered, or wedge-shaped, interlayers that comprise at least one tapered zone having a wedge-shaped profile. Tapered interlayers have a changing thickness profile along at least a portion of the length and/or width of the sheet, such that, for example, at least one edge of the interlayer has a thickness greater than the other. When the interlayer is a tapered interlayer, at least 1, at least 2, at least 3, or more of the individual resin or polymer layers may include at least one tapered zone. Tapered interlayers may be particularly useful in, for example, heads-up display (HUD) panels in automotive and aircraft applications.

In view of the above, embodiments of the present invention include a polymer interlayer that resists formation of optical defects. The polymer interlayer may comprise a core layer, a first skin layer, and a second skin layer. The core layer will generally be positioned between the first and second skin layers, such that the skin layers sandwich the core layer. Notably, the core layer comprises a resin including (i) less than about 10 titers of monovalent alkaline salts, and (ii) an organic acid scavenger in a range from 0.5 to 6 phr.

Beneficially, in such embodiments, the polymer interlayer (or resulting laminated glass panel) will have an improved yellowness index value over other polymer interlayers (or resulting laminated glass panels) formed without organic acid scavengers. For example, the polymer interlayer of the present invention, when laminated between a pair of glass sheets to form a laminated glass panel, may have a yellowness index value of less than 4, less than 3, less than 2, less than 1, and/or less than 0. The “yellowness index” of a polymer interlayer (or resulting laminated glass panel) can be measured according to ASTM D-1925, “Standard Test Method for Yellowness Index of Plastics” from spectrophotometric light transmittance in the visible spectrum. In addition, the polymer interlayer (or resulting laminated glass panel) may have a reduced bubble formation (e.g., edge or trim bubbles) compared to other polymer interlayers (or resulting laminated glass panels) formed without organic acid scavengers.

To facilitate such an improvement in yellowness index value (or reduction in bubble formation) within the interlayer and/or the laminated panel of embodiments of the present invention, the resin forming the core layer of the interlayer may include monovalent alkaline salts amounts of less than about 10 titers, less than about 9 titers, less than about 8 titers, less than about 7 titers, less than about 6 titers, less than about 5 titers, less than about 4 titers, less than about 3 titers, less than about 2 titers, less than about 1 titers, less than about 0.5 titers, and/or about 0 titers (i.e., the core layer includes no monovalent alkaline salts). Alternatively, the resin forming the core layer of the interlayer may include monovalent alkaline salts amounts in the range of about 0 to 10 titers, 0 to 9 titers, 0 to 8 titers, 0 to 7 titers, 0 to 6 titers, 0 to 5 titers, 0 to 4 titers, 0 to 3 titers, 0 to 2 titers, 0 to 1 titers, 1 to 10 titers, 1 to 9 titers, 1 to 8 titers, 1 to 7 titers, 1 to 6 titers, 1 to 5 titers, 1 to 4 titers, 1 to 3 titers, 1 to 2 titers, 2 to 10 titers, 2 to 9 titers, 2 to 8 titers, 2 to 7 titers, 2 to 6 titers, 2 to 5 titers, 2 to 4 titers, 2 to 3 titers, 3 to 10 titers, 3 to 9 titers, 3 to 8 titers, 3 to 7 titers, 3 to 6 titers, 3 to 5 titers, 3 to 4 titers, 4 to 10 titers, 4 to 9 titers, 4 to 8 titers, 4 to 7 titers, 4 to 6 titers, 4 to 5 titers, 5 to 10 titers, 5 to 9 titers, 5 to 8 titers, 5 to 7 titers, 5 to 6 titers, 6 to 10 titers, 6 to 9 titers, 6 to 8 titers, 6 to 7 titers, 7 to 10 titers, 7 to 9 titers, 7 to 8 titers, 8 to 10 titers, 8 to 9 titers, and/or 8 to 10.

The ACA or monovalent alkaline salt concentration within the resins forming the applicable interlayer layers discussed herein is provided in titer units. A “titer” can be determined for sodium acetate, potassium acetate and magnesium salts (as used herein, the “total alkaline titer”) in a sheet sample using the following procedure. To determine the amount of resin in each interlayer sheet sample that is weighed, the following equation can be used, where PHR is defined as the pounds of plasticizer per hundred pounds of resin in the original sheet sample preparation:

$$Grams of resin in sheet sample = \frac{Gram sheet sample}{( 100 + P HR ) / 100}$$

Approximately five grams of resin in the sheet sample is the target mass used to estimate the amount of sheet sample to start the procedure, with the calculated mass of resin in the sheet sample used for each titer determination. All titrations should be completed in the same day. The sheet sample can be dissolved into 250 milliliters of methanol in a beaker. It may take up to eight hours for the sheet sample to be completely dissolved. A blank with only methanol should also prepared in a beaker. The sample and blank should each be titrated with 0.00500 normal hydrogen chloride (HCl) using an automated pH titrator programmed to stop at a pH of 2.5. The amount of HCl added to each the sample and the blank to obtain a pH of 4.2 is recorded. The HCl titer (the total alkalinity titer) should be determined according to the following:

$$HCl Titer [ millileters 0.01 N HCl per 100 g resin ] = \frac{\begin{matrix}50 \times ( millileters of HCl for sample - \\ millileters of HCl for blank )\end{matrix}}{Calculated grams of resin}$$

To determine magnesium salt titer, the following procedure can be implemented. Twelve to fifteen milliliters of pH 10.00 buffer solution, prepared from fifty-four grams of ammonium chloride and three-hundred and fifty milliliters of ammonium hydroxide diluted to one liter with methanol, and twelve to fifteen milliliters of Erichrome Black T indicator should be added to the blank and each sheet sample, all of which have already been titrated with HCl, as described above. The titrant can then be changed to a 0.000298 g/ml ethylenediaminetetraacetic acid (EDTA) solution prepared from 0.3263 g tetrasodium ethylenediaminetetraacetate dihydrate, five milliliter water, diluted to one liter with methanol. The EDTA titration can be measured by light transmittance at 596 nm. The percent transmittance should first be adjusted to 100% in the sample or blank before the titration is started while the solution is a bright magenta-pink color. When transmittance at 596 nm becomes constant, the EDTA titration is complete, and the solution will be a deep indigo color. The volume of EDTA titrated to achieve the indigo blue end point should be recorded for the blank and each sheet sample. Magnesium salt titer is determined according to the following:

$$Magnesium Salt Titer [ as 1 \times {10}^{- 7} mole of \\ magnesium salt per gram resin ] = \frac{\begin{matrix}0.000298 \frac{g}{ml} EDTA \times \\ ( millileters of EDTA for sample - millileters of EDTA for blank )\end{matrix}}{( grams of resin in sheet sample ) \times 380.2 \frac{g}{mole} EDTA \times 1. \times {10}^{- 7}}$$

The portion of the total alkalinity titer attributable to either sodium acetate and/or potassium acetate, as 1×10⁻⁷ mole of acetate salt per gram resin, can be calculated according to the following:

$$Sodium and Potassium Acetate Titer = HCl titer of sheet ( Total Alkaline Titer ) - ( 2 \times Total Magnesium Salt Titer )$$

After determining the portion of the total alkalinity titer attributable to the monovalent alkaline metal salts, such as acetates (such as sodium acetate and/or potassium acetate), destructive analysis on the polymer sheet can be performed by Inductively Coupled Plasma Emission Spectroscopy (ICP) resulting in a ppm concentration for potassium and a ppm concentration for sodium. The alkaline titer attributable to sodium acetate is defined herein as the total alkaline titer attributable to sodium and/or potassium acetate multiplied by the ratio [ppm sodium/(ppm sodium+ppm potassium)]. The alkaline titer attributable to potassium acetate is defined herein as the total alkaline titer attributable to sodium and/or potassium acetate multiplied by the ratio [ppm potassium/(ppm sodium+ppm potassium)]. Another exemplary procedure for determining ACA titer is described in U.S. Pat. No. 5,728,472, which was previously incorporated by reference herein.

The above values and/or ranges of ACA and/or metal salts may comprise various combinations of ACA and/or metal salt types. For instance, as was described above, the metal salts included within the core layer of the interlayers and/or the laminated panels of embodiments of the present invention, may comprise magnesium salts and/or potassium salts. As such, the core layer of the interlayer may include both magnesium salts and potassium salts, but with a total amount of metal salts being no more than about 15 titers, or less than about 10 titers of monovalent alkaline metal salts. In alternative embodiments, the core layer of the interlayer may include potassium salts and no magnesium salts as monovalent alkaline metal salts, but a total amount of monovalent alkaline metal salts still being less than about 10 titers. In still further alternatives, the core layer of the interlayer may include magnesium salts and no potassium salts, but with a total amount of magnesium salts being less than about 10 titers. While magnesium salts function well as acid scavengers in the core or inner layer, too much magnesium salt will cause undesirable bubbles in the sheet, particularly when used in laminated glass. Therefore, the amount of magnesium salt(s) must be balanced or controlled, or it may be used in combination with another metal salt.

Furthermore, to facilitate the improvement in yellowness index value and/or reduction in bubble formation within the interlayer and/or the laminated panel of embodiments of the present invention, the core layer of the interlayer may also include an organic acid scavenger of at least 0.5 phr, at least 1 phr, at least 2 phr, at least 3 phr, at least 4 phr, at least 5 phr, or at least 6 phr. Alternatively, the core layer of the interlayer may include an organic acid scavenger in the range of about 0.5 to 6 phr, 0.5 to 5 phr, 0.5 to 4 phr, 0.5 to 3 phr, 0.5 to 2 phr, 0.5 to 1 phr, 1 to 6 phr, 1 to 5 phr, 1 to 4 phr, 1 to 3 phr, 1 to 2 phr, 2 to 6 phr, 2 to 5 phr, 2 to 4 phr, 2 to 3 phr, 3 to 6 phr, 3 to 5 phr, 3 to 4 phr, 4 to 6 phr, 4 to 5 phr, and/or 5 to 6 phr.

The above-described polymer interlayer, which resists formation of optical defects (e.g., yellowness discoloration and/or bubble formation) may be formed by extruding a first polymer melt to form the core layer and extruding a second polymer melt to form the first and second skin layers. In some embodiments, the first polymer melt will be fed by a first extruder (e.g., a core extruder), while the second polymer melts will be fed by a second extruder (e.g., a skin extruder) and then split into two streams to form the skin layers. The core layer and the skin layers will generally be co-extruded, such that the core layer is positioned between the first and second skin layers. Notably, the first polymer melt, from which the core layer is formed, comprises a resin including (i) less than about 10 titers of monovalent alkaline metal salts, and (ii) an organic acid scavenger in a range from 0.5 to 6 phr.

As such, the polymer interlayer of the present invention (and/or resulting laminated glass panel) will have a reduced yellowness discoloration and/or lower bubble formation than other polymer interlayers (or other laminated glass panels). For example, in some specific embodiments, the polymer interlayer, and/or the resulting laminated glass panel formed via the inventive polymer interlayer laminated between a pair of glass panels, may have a yellowness index value of less than 4, less than 3, less than 2, less than 1, and/or less than 0. Additionally, the polymer interlayer, and/or the resulting laminated glass panel formed via the inventive polymer interlayer laminated between a pair of glass panels, may have a low level of bubbles.

Embodiments may additionally include a method of forming a laminated glass panel with reduced optical defects. Such method may include laminating the above-described polymer interlayer between a pair of glass sheets to form a laminated glass panel. Such glass panel may, in certain embodiments, have a yellowness index value of less than 4, less than 3, less than 2, less than 1, and/or less than 0. Furthermore, in some embodiments, the glass panel may have a reduction in bubble formation (e.g., edge bubbles or trim bubbles), or in other words, the level of bubbles in the glass panel will be lower than that in comparative panels.

In addition to the inventive laminated glass panels described above, which include organic acid scavengers and reduced levels of metal salts in the core layers of the panels' polymer interlayers, embodiments of the present invention may include laminated glass panels (or polymer interlayers for use in laminated glass panels) that resist formation of optical defects and that are formed with polymer interlayers having core layers with no organic acid scavengers but particular types and/or amounts of metal salts. For instance, certain embodiments of the present invention may include a laminated glass panel that comprises a first glass sheet, a second glass sheet, and a polymer layer positioned between the first glass sheet and the second glass sheet. The polymer layer may comprise a resin including no more than about 35 titers of metal salts, including at least 5 titers of a monovalent alkaline metal salt that is potassium acetate.

In certain embodiments the polymer layer may be a core layer forming part of a polymer interlayer. The polymer interlayer may further include a pair of skin layers positioned on either side of the core layer. As such, the polymer interlayer will comprise a trilayer interlayer with a first polymer layer, a second polymer layer, and a third polymer layer, with the first polymer layer being the core layer positioned between the second polymer layer (i.e., a skin layer) and the third polymer layer (i.e., a skin layer). In certain embodiments, the core layer may be formed from a PVB resin, as was described in relation to previous embodiments of the present invention. The resin of the core layer may be formed with metal salts including potassium acetate, magnesium di-2-ethylhexanoate, or combinations thereof. For example, in some embodiments, the resin may comprise at least 10 titers, at least 15 titers, at least 20 titers, and/or at least 25 titers of potassium acetate. Alternatively, or in addition, the resin may comprise no more than 25 titers, no more than 20 titers, no more than 15 titers, no more than 10 titers, and/or no more than 6 titers of potassium acetate. Alternatively, or in addition, the resin may comprise at least 5 titers, at least 10 titers, and/or at least 15 titers of magnesium di-2-ethylhexanoate. Alternatively, or in addition, the resin may comprise no more than 15 titers, no more than 10 titers, and/or no more than 5 titers of magnesium di-2-ethylhexanoate.

Certain specific embodiments of the inventive glass panels may provide for the resin of the core layer to have no more than about 25 titers of a combination of metal salts. In some of such embodiments, the metal salts may be comprised essentially of potassium acetate in an amount of less than 10 titers. In additional embodiments, the inventive glass panels may provide for the resin of the core layer to have no more than about 15 titers of metal salts. In certain of such embodiments, the ACA may be comprised of a combination of potassium acetate and magnesium di-2-ethylhexanoate. For example, the resin of the core layer may include about 6 titers of potassium acetate and about 9 titers of magnesium di-2-ethylhexanoate.

In view of the above, embodiments may provide for laminated glass panels to be manufactured with reduced optical defects by forming the polymer layers of the glass panels having reduced (or no) organic acid scavengers and particular types and amounts of metal salts, such as alkaline metal salts. Such reduced optical defects may be indicated by the glass panels having acceptable yellowness index values. In some embodiments, the yellowness index values may be less than about 1.00, less than about 0.75, less than about 0.50, less than about 0.25, less than about 0.00, less than about −0.25, and/or less than about −0.50. Furthermore, in some embodiments, such glass panels may also have a reduction in bubble formation (e.g., edge bubbles or trim bubbles).

### Example 1

Eleven laminated glass panels (i.e., EX1-GP1-EX1-GP11) were formed, as described in more detail below. Each of the glass panels included a polymer layer formed with a particular amount of plasticizer, adhesion control agent (ACA), and/or organic acid scavenger. Thereafter, as illustrated in Table 1 below, a yellowness index (“YI”) value for each of the glass panels was measured. Specifically, the YI of the glass panels was measured using a spectrophotometer, e.g., a Hunterlab UltraScan XE instrument (commercially available from Hunter Associates, Reston, VA), according to ASTM D-1925 using a spectrophotometric light transmittance in the visible spectrum. For some glass panels, a qualitative assessment of the panel was done to determine whether there was a high (unacceptable) level of bubbles or a low (acceptable) level of bubbles formed in the panel.

In more detail, each of the EX1-GP1-EX1-GP11 glass panels was formed by laminating a polymer sheet between two 2.3 mm clear annealed glass sheets under industrial standard lamination deair and autoclave processes to form a laminated glass sample. For each of the EX1-GP1-EX1-GP10 glass panels, the respective polymer sheet was formed by mixing, within a plastic jar, 50 grams of PVB resin along with the amounts of plasticizer, metal salts, and/or organic acid scavenger listed in Table 1. The PVB resin comprised PVB with 10.5% residual PVOH content by weight and less than 1% residual PVAc content by weight. The plasticizer comprised 3-GEH. The metal salt Type 1 comprised magnesium di-2-ethylhexanoate. The metal salt Type 2 comprised magnesium acetate. The metal salt Type 3 comprised potassium acetate. The organic acid scavenger Type 1 comprised MCS 1562. The organic acid scavenger Type 2 comprised DER 732. The resulting mixture was fed into a Brabender lab melt mixer and melt mixed at a temperature of 170° C. for 7 minutes. The resulting melt was removed from the mixer and pressed into a sheet having a thickness of about 0.76 mm to form a polymer sheet.

TABLE 1

| | | Metal | Metal | Metal | Organic | Organic | | |
|---|---|---|---|---|---|---|---|---|
| | | Salt - | Salt - | Salt - | Acid | Acid | | |
| | | Type | Type | Type | Scavenger - | Scavenger - | | |
| Glass | Plasticizer | 1 | 2 | 3 | Type 1 | Type 2 | | Bubble Level |
| Panel | (phr) | (titer) | (titer) | (titer) | (phr) | (phr) | YI | (High/Low) |
| EX1-GP1 | 50 | | | 6 | 5 | | −0.54 | Low |
| EX1-GP2 | 60 | | | 6 | 5 | | −0.56 | Low |
| EX1-GP3 | 50 | | | 6 | | 5 | −0.47 | Low |
| EX1-GP4 | 60 | | | 6 | | 5 | −0.51 | Low |
| EX1-GP5 | 50 | | | 6 | | | 6.61 | N/A |
| EX1-GP6 | 60 | | | 6 | | | 4.43 | N/A |
| EX1-GP7 | 50 | 9 | | 6 | | | −0.54 | Low |
| EX1-GP8 | 60 | 9 | | 6 | | | −0.65 | Low |
| EX1-GP9 | 50 | | 9 | 6 | | | 6.41 | N/A |
| EX1-GP10 | 60 | | 9 | 6 | | | 4.49 | N/A |
| EX1-GP11 | 50 | | | 25 | | | 0.76 | High |

N/A—not measured

As illustrated by the data from Table 1, and as discussed in more detail below, it was found that glass panels formed with polymer sheets having monovalent alkaline metal salts and organic acid scavengers had beneficially reduced YI values as well as low bubble formation. It is generally understood that lower YI values correspond with reduced yellowness discoloration of polymer layers and/or laminated glass panels with polymer layers, as well as overall improved stability of polymer layers.

Beginning with the EX1-GP9 and EX1-GP10 glass panels, which were formed with the combination of Type 2 metal salt (i.e., magnesium acetate) and the Type 3 metal salt (i.e., potassium acetate) in the polymer sheet, the experimental results showed that such glass panels had unacceptably high YI values at 6.41 and 4.49, respectively. In contrast, the EX1-GP7 and EX1-GP8 glass panels, which were formed with the combination of Type 1 metal salt (i.e., magnesium di-2-ethylhexanoate) and the Type 3 metal salt (i.e., potassium acetate) in the polymer sheet, were found to have acceptable YI values at −0.54 and −0.65, respectively. However, when the Type 1 metal salt was removed from the polymer sheets and there was only a low level of monovalent alkaline metal salt (Type 3 metal salt), as illustrated by EX1-GP5 and EX1-GP6, the unacceptably high YI values returned (i.e., 6.61 and 4.43, respectively).

However, it was found that adding a certain amount of organic acid scavenger to the polymer sheets improved the YI values of the glass panels while also keeping the level of bubble formation low. In more detail, EX1-GP1 through EX1-GP4 illustrate glass panels that were formed with polymer sheets having reduced amounts of monovalent alkaline metal salts (i.e., 6 titers of the Type 3 metal salt, potassium acetate) and 5 phr of organic acid scavenger. The experimental results showed that such glass panels EX1-GP1 through EX1-GP4 had improved reduced YI values (i.e., −0.54, −0.56, −0.47, and −0.51, respectively) as well as acceptable (low) bubble formation. In view of the above, Example 1 illustrates that glass panels formed with polymer layers having low levels of organic acid scavengers in combination with a reduced level of metal salts can have a reduction in optical defects, such as yellowness and bubble formation. Specifically, polymer layers/interlayers formed with organic acid scavengers and reduced levels of metal salts (or glass panels formed with such polymer layers/interlayers) can have reduced yellowness index values, which are associated with reduced discoloration and improved overall stability of the polymer layers, as well as low levels of bubbles.

Returning briefly to the EX1-GP7 and EX1-GP8 glass panels, such glass panels were found to have acceptable YI values (i.e., values below 1.00, at −0.54 and −0.65, respectively) even while including significant amounts of metal salts and no organic acid scavengers in their respective polymer sheets. In more detail, the EX1-GP7 and EX1-GP8 glass panels were formed with a combination of the Type 1 metal salt (i.e., nine titers of magnesium di-2-ethylhexanoate) and the Type 3 metal salt (i.e., six titers of potassium acetate) in the polymer sheets. As such, the data from Example 1 indicates that laminated glass panels with polymer sheets having higher amounts of metal salts, yet no organic acid scavengers, may nonetheless have acceptable YI values depending on the particular types and amounts of metal salts used in the polymer sheets of the laminated glass panels.

The EX1-GP11 glass panel further illustrated that glass panels with polymer sheets having significant amounts of metal salts and no organic acid scavengers may still provide acceptable YI values, but such a high level of metal salts contributed to instability of the layer, as shown by the high level of bubbles formed. In particular, the EX1-GP11 glass panel was formed with only the Type 3 metal salts (i.e., twenty-five titers of potassium acetate) in the polymer sheet. As shown in Table 1, EX1-GP11 glass panel had an acceptable YI value of about 0.76, but a high level of bubbles.

### Comparative Example 1

Six comparative laminated glass panels (i.e., CX1-GP1-CX1-GP6) were formed, in a manner similar to that described above in Example 1 for laminated glass panels EX1-GP1-EX11. In contrast to the panels from Example 1, however, the polymer sheets from the glass panels of this Comparative Example 1 were formed with no organic acid scavengers but varying types of surfactants. Specifically, each respective polymer sheet was formed by mixing within the PVB resin five phr of either a Type 1 surfactant, a Type 2 surfactant, or a Type 3 surfactant. The Type 1 surfactant comprised polyethylene glycol nonylphenol ether, with a degree of polymerization of about ten, and is known under the tradename Surfonic N-102. The Type 2 surfactant comprised polyethylene glycol nonylphenol ether, with a degree of polymerization being about four, and is known under the tradename Surfonic N-40. The Type 3 surfactant comprised alcohols, C12-14-secondary, ethoxylated, with the moles of ethylene oxide being about twelve, and is known under the tradename Tergitol 15-S-12. After formation of the glass panels CX1-GP1-CX1-GP6, a YI value for each of the glass panels was measured, as illustrated below in Table 2.

TABLE 2

| | | Metal | Metal | | | | |
|---|---|---|---|---|---|---|---|
| | | Salt - | Salt - | Surfactant - | Surfactant - | Surfactant - | |
| Glass | Plasticizer | Type 1 | Type 3 | Type 1 | Type 2 | Type 3 | |
| Panel | (phr) | (titer) | (titer) | (phr) | (phr) | (phr) | YI |
| CX1-GP1 | 50 | 18 | 25 | 5 | | | 2.82 |
| CX1-GP2 | 60 | 18 | 25 | 5 | | | 1.26 |
| CX1-GP3 | 50 | 18 | 25 | | 5 | | 1.88 |
| CX1-GP4 | 60 | 18 | 25 | | 5 | | 1.40 |
| CX1-GP5 | 50 | 18 | 25 | | | 5 | 2.23 |
| CX1-GP6 | 60 | 18 | 25 | | | 5 | 1.93 |

As illustrated by the data from Table 2, it was found that glass panels CX1-GP1-CX1-GP6, which were formed with polymer sheets having significant amounts of metal salts (i.e., 43 total titers of metal salts, including 18 titers of Type 1 metal salt and 25 titers of Type 3 metal salt) and no organic acid scavengers, had unacceptably high YI values (i.e., YI values greater than 1.00). Thus, when comparing the glass panels of Comparative Example 1 (i.e., CX1-GP1-CX1-GP6) with the inventive glass panels of Example 1 (i.e., EX1-GP1-EX1-GP4), it is shown that the use of organic acid scavengers in combination with significantly reduced levels of metal salts in polymer layers of laminated glass panels can provide a reduction in optical defects (yellowness and/or bubble formation) of the glass panels.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, a polymer layer can be formed comprising plasticizer content in any of the ranges given in addition to any of the ranges given for residual hydroxyl content, where appropriate, to form many permutations that are within the scope of the present invention but that would be cumbersome to list.

The present invention and its preferred embodiments is now further described in terms of numbered Items 1 to 95.

Item 1. A polymer interlayer that resists formation of optical defects, the polymer interlayer comprising: a first polymer layer; a second polymer layer; and a third polymer layer, wherein said first polymer layer is positioned between said second polymer layer and said third polymer layer, wherein said first polymer layer comprises a resin including (i) less than about 10 titers of monovalent alkaline metal salts, and (ii) an organic acid scavenger in a range of 0.5 to 6 phr.

Item 2. The polymer interlayer of Item 1, wherein the resin of the first polymer layer comprises poly(vinyl butyral).

Item 3. The polymer interlayer of Item 1, wherein the monovalent alkaline metal salt in the first polymer layer comprises a potassium salt.

Item 4. The polymer interlayer of Item 1, wherein the monovalent alkaline metal salt in the first polymer layer is less than about 9 titers, less than about 8 titers, less than about 7 titers, less than about 6 titers, less than about 5 titers, less than about 4 titers, less than about 3 titers, less than about 2 titers, less than about 1 titers, less than about 0.5 titers, and/or about 0 titers.

Item 5. The polymer interlayer of Item 1, wherein the organic acid scavenger in the first polymer layer comprises an epoxide derivative.

Item 6. The polymer interlayer of Item 5, wherein the epoxide derivative comprises a mono-epoxide.

Item 7. The polymer interlayer of Item 5, wherein the epoxide derivative comprises a di-epoxide.

Item 8. The polymer interlayer of Item 5, wherein the epoxide derivative comprises an epoxidized vegetable oil.

Item 9. The polymer interlayer of Item 1, wherein the organic acid scavenger in the first polymer layer is in the range of about 0.5 to 5 phr, 0.5 to 4 phr, 0.5 to 3 phr, 1 to 6 phr, 1 to 5 phr, 1 to 4 phr, 1 to 3 phr, 2 to 6 phr, 2 to 5 phr, 2 to 4 phr, 2 to 3 phr, 3 to 6 phr, 3 to 5 phr, 3 to 4 phr, 4 to 6 phr, 4 to 5 phr, and/or 5 to 6 phr.

Item 10. The polymer interlayer of Item 1, wherein when said polymer interlayer is laminated between a pair of glass sheets to form a laminated glass panel, such glass panel has a yellowness index value of less than 4, less than 3, less than 2, less than 1, and/or less than 0.

Item 11. The polymer interlayer of Item 1, wherein a thickness of said polymer interlayer is generally constant along a length of said polymer interlayer.

Item 12. The polymer interlayer of Item 1, wherein a thickness of said polymer interlayer varies along a length of said polymer interlayer, such that said polymer interlayer has a wedge shape.

Item 13. The polymer interlayer of Item 1, wherein said first polymer layer is softer than said second and third polymer layers.

Item 14. A laminated glass panel that resists formation of optical defects, the laminated glass panel comprising: a first glass sheet; a second glass sheet; and a polymer interlayer laminated between said first glass sheet and said second glass sheet, wherein said polymer interlayer comprises—a first polymer layer, a second polymer layer, and a third polymer layer, wherein said first polymer layer is positioned between said second polymer layer and said third polymer layer, wherein said first polymer layer comprises a resin including (i) less than about 10 titers of monovalent alkaline metal salts, and (ii) an organic acid scavenger in a range of 0.5 to 6 phr.

Item 15. The laminated glass of Item 14, wherein the resin of the first polymer layer comprises poly(vinyl butyral).

Item 16. The laminated glass of Item 14, wherein the monovalent alkaline metal salt in the first polymer layer comprises a potassium salt.

Item 17. The laminated glass of Item 14, wherein the monovalent alkaline metal salt in the first polymer layer is less than about 9 titers, less than about 8 titers, less than about 7 titers, less than about 6 titers, less than about 5 titers, less than about 4 titers, less than about 3 titers, less than about 2 titers, less than about 1 titers, less than about 0.5 titers, and/or about 0 titers.

Item 18. The laminated glass of Item 14, wherein the organic acid scavenger in the first polymer layer comprises an epoxide derivative.

Item 19. The laminated glass of Item 18, wherein the epoxide derivative comprises a mono-epoxide.

Item 20. The laminated glass of Item 18, wherein the epoxide derivative comprises a di-epoxide.

Item 21. The laminated glass of Item 18, wherein the epoxide derivative comprises an epoxidized vegetable oil.

Item 22. The laminated glass of Item 14, wherein the organic acid scavenger in the first polymer layer is in the range of about 0.5 to 5 phr, 0.5 to 4 phr, 0.5 to 3 phr, 1 to 6 phr, 1 to 5 phr, 1 to 4 phr, 1 to 3 phr, 2 to 6 phr, 2 to 5 phr, 2 to 4 phr, 2 to 3 phr, 3 to 6 phr, 3 to 5 phr, 3 to 4 phr, 4 to 6 phr, 4 to 5 phr, and/or 5 to 6 phr.

Item 23. The laminated glass of Item 14, wherein when said polymer interlayer is laminated between a pair of glass sheets to form a laminated glass panel, such glass panel has a yellowness index value of less than 4, less than 3, less than 2, less than 1, and/or less than 0.

Item 24. A polymer interlayer that resists formation of optical defects, the polymer interlayer comprising: a first polymer layer; a second polymer layer; and a third polymer layer, wherein said first polymer layer is positioned between said second and said third polymer layers, wherein said first polymer layer comprises a resin including (i) no more than about 15 titers of a first alkaline metal salt and a second alkaline metal salt.

Item 25. The polymer interlayer of Item 24, wherein the resin of the first polymer layer comprises poly(vinyl butyral).

Item 26. The polymer interlayer of Item 24, wherein the first alkaline metal salt in the first polymer layer comprises a magnesium salt.

Item 27. The polymer interlayer of Item 24, wherein the second alkaline metal salt in the first polymer layer comprises a potassium salt.

Item 28. The polymer interlayer of Item 24, wherein the first alkaline metal salt and the second alkaline metal salt in the first polymer layer comprises a combination of magnesium salt and potassium salt.

Item 29. The polymer interlayer of Item 24, wherein the first polymer layer further comprises an organic acid scavenger.

Item 30. The polymer interlayer of Item 24, wherein the each of the first and second alkaline metal salts in the first polymer layer are present in an amount of less than about 9 titers, less than about 8 titers, less than about 7 titers, less than about 6 titers, less than about 5 titers, less than about 4 titers, less than about 3 titers, less than about 2 titers, less than about 1 titers, less than about 0.5 titers, and/or about 0 titers.

Item 31. The polymer interlayer of Item 24, wherein the organic acid scavenger in the first polymer layer comprises an epoxide derivative.

Item 32. The polymer interlayer of Item 31, wherein the epoxide derivative comprises a mono-epoxide.

Item 33. The polymer interlayer of Item 31, wherein the epoxide derivative comprises a di-epoxide.

Item 34. The polymer interlayer of Item 31, wherein the epoxide derivative comprises an epoxidized vegetable oil.

Item 35. The polymer interlayer of Item 29, wherein the organic acid scavenger in the first polymer layer is in the range of about 0.5 to 5 phr, 0.5 to 4 phr, 0.5 to 3 phr, 1 to 6 phr, 1 to 5 phr, 1 to 4 phr, 1 to 3 phr, 2 to 6 phr, 2 to 5 phr, 2 to 4 phr, 2 to 3 phr, 3 to 6 phr, 3 to 5 phr, 3 to 4 phr, 4 to 6 phr, 4 to 5 phr, and/or 5 to 6 phr.

Item 36. The polymer interlayer of Item 24, wherein when said polymer interlayer is laminated between a pair of glass sheets to form a laminated glass panel, such glass panel has a yellowness index value of less than 4, less than 3, less than 2, less than 1, and/or less than 0.

Item 37. The polymer interlayer of Item 24, wherein a thickness of said polymer interlayer is generally constant along a length of said polymer interlayer.

Item 38. The polymer interlayer of Item 24, wherein a thickness of said polymer interlayer varies along a length of said polymer interlayer, such that said polymer interlayer has a wedge shape.

Item 39. The polymer interlayer of Item 24, wherein said first polymer layer is softer than said second and third polymer layers.

Item 40. A method of forming a polymer interlayer that resists formation of optical defects, said method comprising the steps of: (a) extruding a first polymer melt to form a first polymer layer; and (b) extruding a second polymer melt to form a second polymer layer and a third polymer layer; wherein upon said extruding of steps (a) and (b), the first polymer layer is positioned between said second and third polymer layers, wherein the first polymer layer comprises a resin including (i) a monovalent alkaline metal salt of less than about 10 titers, and (ii) an organic acid scavenger in a range of 0.5 to 6 phr.

Item 41. The method of Item 40, wherein said extruding of steps (a) and (b) is performed via co-extrusion, wherein the resin of the first polymer layer comprises PVB, and wherein the monovalent alkaline metal salt in the first polymer layer comprises a potassium salt.

Item 42. The method of Item 40, wherein the resin of the first polymer layer includes no magnesium salt.

Item 43. The method of Item 40, wherein the monovalent alkaline metal salt in the first polymer layer is less than about 9 titers, less than about 8 titers, less than about 7 titers, less than about 6 titers, less than about 5 titers, less than about 4 titers, less than about 3 titers, less than about 2 titers, less than about 1 titers, less than about 0.5 titers, and/or about 0 titers.

44. The method of Item 40, wherein the organic acid scavenger in the first polymer layer comprises an epoxide derivative.

Item 45. The method of Item 40, wherein the organic acid scavenger in the first polymer layer is in the range of about 0.5 to 5 phr, 0.5 to 4 phr, 0.5 to 3 phr, 1 to 6 phr, 1 to 5 phr, 1 to 4 phr, 1 to 3 phr, 2 to 6 phr, 2 to 5 phr, 2 to 4 phr, 2 to 3 phr, 3 to 6 phr, 3 to 5 phr, 3 to 4 phr, 4 to 6 phr, 4 to 5 phr, and/or 5 to 6 phr.

Item 46. The method of Item 40, further including the step of: (c) laminating the polymer interlayer between a pair of glass sheets to form a laminated glass panel, wherein upon said laminating of step (c), the laminated glass panel has a yellowness index value of less than 4, less than 3, less than 2, less than 1, and/or less than 0.

Item 47. The method of Item 40, wherein a thickness of the polymer interlayer is generally constant along a length of the polymer interlayer.

Item 48. The method of Item 40, wherein a thickness of the polymer interlayer varies along a length of the polymer interlayer, such that said polymer interlayer has a wedge shape.

Item 49. The method of Item 40, wherein the first polymer layer is softer than the second and third polymer layers.

Item 50. A method of forming a polymer interlayer that resists formation of optical defects, said method comprising the steps of: (a) extruding a first polymer melt to form a first polymer layer; and (b) extruding a second polymer melt to form a second polymer layer and a third polymer layer; wherein upon said extruding of steps (a) and (b), the first polymer layer is positioned between said second and third polymer layers, wherein said first polymer layer comprises a resin including (i) no more than about 15 titers of a first alkaline metal salt and a second alkaline metal salt.

Item 51. The method of Item 50, wherein said extruding of steps (a) and (b) is performed via co-extrusion, wherein the resin of the first polymer layer comprises poly(vinyl butyral), and wherein the first alkaline metal salt in the first polymer layer comprises a magnesium salt.

Item 52. The method of Item 50, wherein the second alkaline metal salt in the first polymer layer comprises a potassium salt.

Item 53. The method of Item 50, wherein the first alkaline metal salt and the second alkaline metal salt in the first polymer layer comprises a combination of magnesium salt and potassium salt.

Item 54. The method of Item 50, wherein the first polymer layer further comprises an organic acid scavenger.

Item 55. The method of Item 50, wherein the each of the first and second alkaline metal salts in the first polymer layer are present in an amount of less than about 9 titers, less than about 8 titers, less than about 7 titers, less than about 6 titers, less than about 5 titers, less than about 4 titers, less than about 3 titers, less than about 2 titers, less than about 1 titers, less than about 0.5 titers, and/or about 0 titers.

Item 56. The method of Item 50, further including the step of: (c) laminating the polymer interlayer between a pair of glass sheets to form a laminated glass panel, wherein upon said laminating of step (c), the laminated glass panel has a yellowness index value of less than 4, less than 3, less than 2, less than 1, and/or less than 0.

Item 57. The method of Item 50, wherein a thickness of the polymer interlayer is generally constant along a length of the polymer interlayer.

Item 58. The method of Item 50, wherein a thickness of the polymer interlayer varies along a length of the polymer interlayer, such that said polymer interlayer has a wedge shape.

Item 59. The method of Item 50, wherein the first polymer layer is softer than the second and third polymer layers.

Item 60. A polymer interlayer that resists formation of optical defects, the polymer interlayer comprising: a first polymer layer, a second polymer layer, and a third polymer layer, wherein said first polymer layer is positioned between said second polymer layer and said third polymer layer, wherein said first polymer layer comprises a resin including no more than about 35 titers of alkaline metal salt, wherein at least 5 titers of the alkaline metal salt is potassium acetate.

Item 61. The polymer interlayer of Item 60, wherein the resin of said first polymer layer of said polymer interlayer comprises no more than about 25 titers of alkaline metal salt.

Item 62. The polymer interlayer of Item 60, wherein the alkaline metal salt is comprised essentially of potassium acetate.

Item 63. The polymer interlayer of Item 60, wherein the resin of said first polymer layer of said polymer interlayer comprises no more than about 15 titers of alkaline metal salt.

Item 64. The polymer interlayer of Item 60, wherein the alkaline metal salt comprises a combination of potassium acetate and magnesium di-2-ethylhexanoate.

Item 65. The polymer interlayer of Item 60, wherein the alkaline metal salt comprises about 6 titers of potassium acetate.

Item 66. The polymer interlayer of Item 60, wherein the alkaline metal salt comprises about 9 titers of magnesium di-2-ethylhexanoate.

Item 67. The polymer interlayer of Item 60, wherein the resin of said first polymer layer of said polymer interlayer comprises at least 10, at least 15, at least 20, and/or at least 25 titers of potassium acetate.

Item 68. The polymer interlayer of Item 60, wherein the resin of said first polymer layer of said polymer interlayer comprises no more than 25, no more than 20, no more than 15, no more than 10, and/or no more than 6 titers of potassium acetate.

Item 69. The polymer interlayer of Item 60, wherein the resin of said first polymer layer of said polymer interlayer comprises at least 5, at least 10, and/or at least 15 titers of magnesium di-2-ethylhexanoate.

Item 70. The polymer interlayer of Item 60, wherein the resin of said first polymer layer of said polymer interlayer comprises no more than 15, no more than 10, and/or no more than 5 titers of magnesium di-2-ethylhexanoate.

Item 71. A laminated glass panel that resists formation of optical defects, the laminated glass panel comprising: a first glass sheet; a second glass sheet; and a polymer interlayer laminated between said first glass sheet and said second glass sheet, wherein said polymer interlayer comprises—a first polymer layer, a second polymer layer, and a third polymer layer, wherein said first polymer layer is positioned between said second polymer layer and said third polymer layer, wherein said first polymer layer comprises a resin including no more than about 35 titers of alkaline metal salt, wherein at least 5 titers of the alkaline metal salt is potassium acetate.

Item 72. The laminated glass panel of Item 71, wherein the resin of said first polymer layer of said polymer interlayer comprises no more than about 25 titers of alkaline metal salt.

Item 73. The laminated glass panel of Item 71, wherein the alkaline metal salt is comprised essentially of potassium acetate.

Item 74. The laminated glass panel of Item 71, wherein the resin of said first polymer layer of said polymer interlayer comprises no more than about 15 titers of alkaline metal salt.

Item 75. The laminated glass panel of Item 71, wherein the alkaline metal salt comprises a combination of potassium acetate and magnesium di-2-ethylhexanoate.

Item 76. The laminated glass panel of Item 71, wherein the alkaline metal salt comprises about 6 titers of potassium acetate.

Item 77. The laminated glass panel of Item 71, wherein the alkaline metal salt comprises about 9 titers of magnesium di-2-ethylhexanoate.

Item 78. The laminated glass panel of Item 71, wherein the resin of said first polymer layer of said polymer interlayer comprises at least 10, at least 15, at least 20, and/or at least 25 titers of potassium acetate.

Item 79. The laminated glass panel of Item 71, wherein the resin of said first polymer layer of said polymer interlayer comprises no more than 25, no more than 20, no more than 15, no more than 10, and/or no more than 6 titers of potassium acetate.

Item 80. The laminated glass panel of Item 71, wherein the resin of said first polymer layer of said polymer interlayer comprises at least 5, at least 10, and/or at least 15 titers of magnesium di-2-ethylhexanoate.

Item 81. The laminated glass panel of Item 71, wherein the resin of said first polymer layer of said polymer interlayer comprises no more than 15, no more than 10, and/or no more than 5 titers of magnesium di-2-ethylhexanoate.

Item 82. The laminated glass panel of Item 71, wherein said laminated glass panel has a yellowness index value of less than about 1.00.

Item 83. The laminated glass panel of Item 71, wherein the yellowness index value of said laminated glass panel is less than about 0.75, less than about 0.50, less than about 0.25, less than about 0.00, less than about −0.25, and/or less than about −0.50.

Item 84. A method of forming a polymer interlayer that resists formation of optical defects, said method comprising the steps of: (a) extruding a first polymer melt to form a first polymer layer; and (b) extruding a second polymer melt to form a second polymer layer and a third polymer layer; wherein upon said extruding of steps (a) and (b), the first polymer layer is positioned between said second and third polymer layers, wherein said first polymer layer comprises a resin including no more than about 35 titers of alkaline metal salt, wherein at least 5 titers of the alkaline metal salt is potassium acetate.

Item 85. The method of Item 84, wherein said extruding of steps (a) and (b) is performed via co-extrusion, wherein the resin of the first polymer layer comprises poly(vinyl butyral), and wherein the resin of said first polymer layer of said polymer interlayer comprises no more than about 25 titers of alkaline metal salt.

Item 86. The method of Item 84, wherein the alkaline metal salt is comprised essentially of potassium acetate.

Item 87. The method of Item 84, wherein the resin of said first polymer layer of said polymer interlayer comprises no more than about 15 titers of alkaline metal salt.

Item 88. The method of Item 84, wherein the alkaline metal salt comprises a combination of potassium acetate and magnesium di-2-ethylhexanoate.

Item 89. The method of Item 84, wherein the alkaline metal salt comprises about 6 titers of potassium acetate.

Item 90. The method of Item 84, wherein the alkaline metal salt comprises about 9 titers of magnesium di-2-ethylhexanoate.

Item 91. The method of Item 84, further including the step of: (c) laminating the polymer interlayer between a pair of glass sheets to form a laminated glass panel, wherein upon said laminating of step (c), the laminated glass panel has a wherein said laminated glass panel has a yellowness index value of less than about 1.00.

Item 92. The method of Item 84, further including the step of: (c) laminating the polymer interlayer between a pair of glass sheets to form a laminated glass panel, wherein upon said laminating of step (c), the laminated glass panel has a wherein said laminated glass panel has a yellowness index value of less than about 0.75, less than about 0.50, less than about 0.25, less than about 0.00, less than about −0.25, and/or less than about −0.50.

Item 93. The method of Item 84, wherein a thickness of the polymer interlayer is generally constant along a length of the polymer interlayer.

Item 94. The method of Item 84, wherein a thickness of the polymer interlayer varies along a length of the polymer interlayer, such that said polymer interlayer has a wedge shape.

Item 95. The method of Item 84, wherein the first polymer layer is softer than the second and third polymer layers.

1. A polymer interlayer that resists formation of optical defects, the polymer interlayer comprising:
a first polymer layer;
a second polymer layer; and
a third polymer layer,
wherein said first polymer layer is positioned between said second polymer layer and said third polymer layer,
wherein said first polymer layer comprises a resin including (i) less than about 10 titers of monovalent alkaline metal salts, and (ii) an organic acid scavenger in a range of 0.5 to 6 phr.

2. The polymer interlayer of claim 1, wherein the resin of the first polymer layer comprises poly(vinyl butyral) or wherein the monovalent alkaline metal salt in the first polymer layer comprises a potassium salt, and wherein the monovalent alkaline metal salt in the first polymer layer is less than about 7 titers.

3. The polymer interlayer of claim 1, wherein the organic acid scavenger comprises an epoxide derivative selected from a mono-epoxide, or a di-epoxide, or an epoxidized vegetable oil.

4. The polymer interlayer of claim 1, wherein the organic acid scavenger in the first polymer layer is in the range of about 1 to 6 phr.

5. The polymer interlayer of claim 1, wherein when said polymer interlayer is laminated between a pair of glass sheets to form a laminated glass panel, such glass panel has a yellowness index value of less than 4.

6-10. (canceled)

11. A polymer interlayer that resists formation of optical defects, the polymer interlayer comprising:
a first polymer layer,
a second polymer layer, and
a third polymer layer,
wherein said first polymer layer is positioned between said second polymer layer and said third polymer layer,
wherein said first polymer layer comprises a resin including no more than about 25 titers of alkaline metal salt, wherein at least 5 titers of the alkaline metal salt is potassium acetate.

12. The polymer interlayer of claim 11, and wherein the alkaline metal salt comprises a combination of potassium acetate and magnesium di-2-ethylhexanoate.

13. The polymer interlayer of claim 1, wherein a thickness of said polymer interlayer varies along a length of said polymer interlayer, such that said polymer interlayer has a wedge shape, and wherein said first polymer layer is softer than said second and third polymer layers.

14. A laminated glass panel that resists formation of optical defects, the laminated glass panel comprising:
a first glass sheet;
a second glass sheet; and
the polymer interlayer of claim 1.

15. The laminated glass panel of claim 14, wherein said laminated glass panel has a yellowness index value of less than about 1.00.

16. A method of forming a polymer interlayer that resists formation of optical defects, said method comprising the steps of:
(a) extruding a first polymer melt to form a first polymer layer; and
(b) extruding a second polymer melt to form a second polymer layer and a third polymer layer;
wherein upon said extruding of steps (a) and (b), the first polymer layer is positioned between said second and third polymer layers,
wherein the first polymer layer comprises a resin including (i) a monovalent alkaline metal salt of less than about 10 titers, and (ii) an organic acid scavenger in a range of 0.5 to 6 phr.

17. The method of claim 16, wherein said extruding of steps (a) and (b) is performed via co-extrusion, wherein the resin of the first polymer layer comprises PVB and wherein the monovalent alkaline metal salt in the first polymer layer is less than about 9 titers, and wherein the organic acid scavenger in the first polymer layer comprises an epoxide derivative.

18. The method of claim 16, wherein the organic acid scavenger in the first polymer layer is in the range of 2 to 6 phr.

19. The method of claim 16, further including the step of:
(c) laminating the polymer interlayer between a pair of glass sheets to form a laminated glass panel,
wherein upon said laminating of step (c), the laminated glass panel has a yellowness index value of less than 4.

20. (canceled)
